(19) United States
(12) Patent Application Publication
(10) Pub. No.: US 2026/0048790 A1
(43) Pub. Date: Feb. 19, 2026

(54) Controller and Method for Controlling the Operation of a Motor Vehicle

(71) Applicant: BAYERISCHE MOTOREN WERKE AKTIENGESELLSCHAFT, München (DE)

(72) Inventor: Jakob HUEMER, Muenchen (DE)

(21) Appl. No.: 19/126,526

(22) PCT Filed: Nov. 8, 2023
(86) PCT No.: PCT/EP2023/081127

§ 371 Date: May 1, 2025

(30) Foreign Application Priority Data
Nov. 11, 2022 (DE) 10 2022 129 908.2

(51) Int. Cl. B62D 15/02; B62D 6/00

(52) U.S. Cl. CPC B62D 15/025; B62D 6/00

(57) ABSTRACT

A controller for controlling the operation of a motor vehicle includes an electronic control unit that ascertains a target trajectory for a turning maneuver of the motor vehicle, ascertains the curve of the radius and/or the curvature of the curve of the target trajectory based on the target trajectory, and controls the steering of the motor vehicle based on the ascertained curve of the radius and/or the curvature of the curve. The steering is controlled via a continuous control of the steering ratio and/or the setting of a fixed value for the steering ratio.

### BACKGROUND AND SUMMARY

This disclosure relates to a control device, or control unit, for controlling the operation of a motor vehicle, to a motor vehicle comprising the control device and/or to a (control) method for controlling the operation of a motor vehicle. Additionally or alternatively, a computer program is provided which comprises commands that, when the program is executed by a computer, cause said computer to carry out the method at least in part. Additionally or alternatively, a computer-readable medium is provided which comprises commands that, when the commands are executed by a computer, cause said computer to carry out the method at least in part.

Driver assistance systems are increasingly being installed in modern motor vehicles, in particular automobiles.

Driver assistance systems ((Advanced) Driver Assistance Systems (A(DAS))) are electronic, in particular mechatronic, devices in motor vehicles for assisting the driver in specific driving situations. They often place emphasis on safety aspects, but also on improving driving comfort.

Driver assistance systems exist which are designed to control longitudinal and lateral guidance of a motor vehicle in an automated manner. This can include, among other things, assisted turning in intersection situations in urban surroundings, with so-called steer-by-wire systems meaning that there is increased potential for closed-loop control options for driver assistance systems compared to conventional steerings with mechanical force transmission.

However, the conventional driver assistance systems described above can require, among other things, the driver to change their grip during automated, or assisted, turning, which involves a steering wheel of the motor vehicle being moved in an automated manner.

Against the background of this prior art, the object of this disclosure is to specify an improved device and/or an improved method, each of which is suitable for enriching the prior art.

The object is achieved by the features of the various embodiments, and aspects thereof, described herein.

Accordingly, the object is achieved by a control device for controlling the operation of a motor vehicle, the control device being designed to identify a profile of a curve radius and/or curve curvature, and control a steering of the motor vehicle on the basis of the identified profile of the curve radius and/or curve curvature. The control of the steering comprises continuous control of a steering ratio of the steering, and/or setting of a fixed value for the steering ratio, on the basis of the curve radius and/or curve curvature, optionally according to a mean value of the curve radius and/or curve curvature.

The control device, or control unit, may be part of the driving assistance system or may constitute said driving assistance system. The control device may be an electronic control unit (ECU), for example. The electronic control unit may be an intelligent processor-controlled unit that e.g. can communicate with other modules via a central gateway (CGW) and that, if applicable, can form the vehicle electrical system by way of field buses, such as the CAN bus, LIN bus, MOST bus, FlexRay and/or by way of automotive Ethernet, e.g. together with telematics controllers and/or an environment sensor system.

It is conceivable for the control device to control functions relevant to the driving behavior of the motor vehicle, such as steering, engine control, force transmission and/or the braking system. Additionally, driver assistance systems, for example a park assist system, an adaptive cruise control (ACC) system, a lane departure warning system, a lane-change assist system, a traffic-sign recognition system, a traffic light recognition system, a hill-start assist system, a night vision assist system and/or an intersection assist system, can be controlled by the control device.

The term ‘curve radius’, or ‘radius of a curve’, can be understood to mean the radius that the motor vehicle uses when it follows a target trajectory through the curve. In accordance with some embodiments, the term ‘curve radius’ can also be understood to mean the radius of the curve, or of the road or lane, as represented on a digital map or according to an environment model (e.g. among other things based on an optical capture by means of a camera). The same applies to the term ‘curve curvature’.

The profile of the curve radius means the size thereof, or the magnitude thereof, optionally also a change in the magnitude, over the course of cornering. The same applies to the profile of the curve curvature.

Cornering may be a turning maneuver and/or driving through in particular tight curves, e.g. at a switchback when driving on a winding road.

Where the term “controlling” or “control” is used herein, this is intended to be understood to mean open-loop and/or closed-loop control.

During cornering, the (automated) control of the steering can be provided, according to some embodiments, in support of otherwise manual lateral guidance of the motor vehicle. In other embodiments, the automated control of the steering can manage without manual intervention.

The control device described above affords a series of advantages. Among other things, it permits a steering wheel angle to be adjusted in longitudinally and laterally guided turning situations in consideration of the curve radius and/or curve curvature in the turning situations, as described in more detail below.

Possible developments of the control device described above are outlined in detail below.

The control device may be designed to identify a target trajectory of the motor vehicle for a cornering and to identify the profile of the curve radius and/or curve curvature on the basis of the target trajectory.

Where the terms “target” and “actual” are used herein, the target value means a desired value or a value to be attained. The actual value, on the other hand, is the value that actually exists in reality.

The term ‘trajectory’ can be understood to mean a path along which the motor vehicle moves or is supposed to move. Besides location, or position, information, the trajectory may also include a temporal component, i.e. when the motor vehicle is supposed to be where.

The control device may be designed to determine the target trajectory on the basis of a present position of the motor vehicle and map data.

According to some embodiments, there may be provision for the target trajectory to be determined on the basis of the profile of the curve radius and/or curve curvature.

The map data can comprise a lane centerline of a turning lane and/or a trajectory of at least one motor vehicle that has already performed the cornering, and the control device may be designed to identify the target trajectory on the basis of the lane centerline and/or the trajectory.

The control device may be designed to determine the target trajectory on the basis of a longitudinal and lane guidance that has been determined on the basis of sensor data from an environment sensor system of the motor vehicle.

The control device may be designed to take into consideration a yaw rate, a longitudinal acceleration and/or a lateral acceleration of the motor vehicle, which has or have been determined on the basis of sensor data from at least one driving dynamics sensor of the motor vehicle, when generating the control signal.

The steering can be controlled such that a steering wheel angle of a steering wheel of the steering of the motor vehicle does not exceed a predetermined maximum steering wheel angle.

The description above can be summarized in other words and to provide a possible more concrete form of the disclosure as described below, the description below not being intended to be interpreted as limiting the disclosure.

In general, a driving situation can be assumed in which a (motor) vehicle enters an intersection in a longitudinally/laterally guided manner with the assistance of an ADAS system and performs a left or right turning maneuver. Lane-accurate positioning of the vehicle on entering the intersection, and map information, e.g. pertaining to a measured lane centerline of the turning lane, allows a target trajectory to be identified for the turning maneuver. The map information in this case can e.g. also be determined from statistical evaluations of trajectories used by a vehicle fleet during the turning maneuver. The target trajectory can also be derived from a lane guidance identified by way of the environment sensor system of the vehicle (e.g. radar, lidar, camera system with image processing, etc.).

The target trajectory thus obtained can be used to identify the profile of the curve radius and/or curve curvature of the trajectory of the turning maneuver. Besides consideration of yaw rate, longitudinal acceleration and lateral acceleration from driving dynamics sensors, knowledge of the profile of the curve radius and/or curve curvature of the target trajectory allows closed-loop control of the steering ratio to be used to produce a defined response for the rotational movement of the steering wheel of the vehicle. The steering wheel movement can therefore be closed-loop controlled, among other things, on the basis of the curve radius and/or curve curvature to be produced.

The steering ratio can be continuously closed-loop controlled according to the profile of the curve radius and/or curve curvature or can be set to a permanently selected value, e.g. according to the minimum or maximum occurring curve radius and/or curve curvature of the turning maneuver.

The steering ratio between the steering wheel angle and the steering angle produced can be controlled, optionally closed-loop controlled, by various methods/systems, e.g. by adapting a steering ratio at a front axle steering by means of a variable speed transmission (so-called “active front axle steering”), by adapting a steering ratio by setting a steering angle at an active rear axle steering and/or by adapting a steering ratio of a steer-by-wire system at the front and/or rear axle.

Specifically, a driving situation can be assumed in which a vehicle enters an intersection in a longitudinally/laterally guided manner with the assistance of an ADAS system and performs a right turning maneuver with a minimum curve radius of e.g. 10 m. The lane-accurate positioning of the vehicle on entering the intersection situation, and a measured centerline, can be used to identify the target trajectory and the target speed profile of the turning maneuver. Besides the controlling steering torques to be produced for the lateral control from signals from the driving dynamics sensors relating to yaw rate, longitudinal acceleration and lateral acceleration and also control logic or a model for mapping the vehicle dynamics, a target profile of the steering ratio can be identified in order to produce a defined steering wheel angle response that makes it unnecessary to change one's grip on the steering wheel during the turning maneuver. A steer-by-wire system can be used to set the steering torques to be produced using an appropriate steering ratio.

Furthermore, a motor vehicle comprising the control unit described above is provided.

The motor vehicle may be a passenger car, in particular an automobile, or a commercial vehicle, such as a truck.

The motor vehicle may be automated. The motor vehicle may be designed to use the control device to undertake longitudinal guidance and/or lateral guidance during automated driving of the motor vehicle at least in part and/or at least at times.

The automated driving can be performed such that the motor vehicle moves (largely) autonomously. The automated driving can be controlled by the control device at least in part and/or at times.

It is conceivable for the motor vehicle to use a driving assistance system to intervene in the lateral guidance of the motor vehicle actively, e.g. by adapting an actual steering wheel position, and optionally passively, e.g. by displaying turning advice.

The description above with reference to the control device also applies analogously to the motor vehicle, and vice versa.

Furthermore, a method for controlling the operation of a motor vehicle is specified, the method comprising identifying a profile of a curve radius and/or curve curvature, and controlling a steering of the motor vehicle on the basis of the identified profile of the curve radius and/or curve curvature. The control of the steering comprises continuous control of a steering ratio of the steering, and/or setting of a fixed value for the steering ratio, on the basis of the curve radius and/or curve curvature, optionally according to a mean value of the curve radius and/or curve curvature.

The control method may be a computer-implemented method, i.e. one, multiple or all steps of the method can be carried out at least in part by a computer or a device for data processing, optionally the control device.

The description above with reference to the control device and the motor vehicle also applies analogously to the control method, and vice versa.

Furthermore, a computer program comprising commands that, when the program is executed by a computer, cause said computer to carry out or perform the method described above at least in part is provided.

A program code of the computer program may be in any code, in particular in a code that is suitable for controllers of motor vehicles.

The description above with reference to the control device, the motor vehicle and the method also applies analogously to the computer program, and vice versa.

Furthermore, a computer-readable medium, in particular a computer-readable storage medium, is provided. The computer-readable medium comprises commands that, when the commands are executed by a computer, cause said computer to carry out the method described above at least in part.

That is to say that a computer-readable medium can be provided that comprises a computer program as defined above. The computer-readable medium may be any digital data storage device, for example a USB stick, a hard disk, a CD-ROM, an SD card or an SSD card.

The computer program does not necessarily have to be stored on a computer-readable storage medium such as this in order to be made available to the motor vehicle, but can also be obtained via the Internet or by other external means.

The description above with reference to the method, the control device, the computer program and the motor vehicle also applies analogously to the computer-readable medium, and vice versa.

An embodiment is described below with reference to FIGS. 1 and 2.

### BRIEF DESCRIPTION OF THE DRAWINGS

FIG. 1 schematically shows a bird's eye view of a motor vehicle comprising a control device according to the disclosure in an illustrative driving situation, and

FIG. 2 schematically shows a flowchart for a method according to the disclosure for controlling the operation of the motor vehicle, carried out by the control device in the driving situation shown in FIG. 1.

### DETAILED DESCRIPTION OF THE DRAWINGS

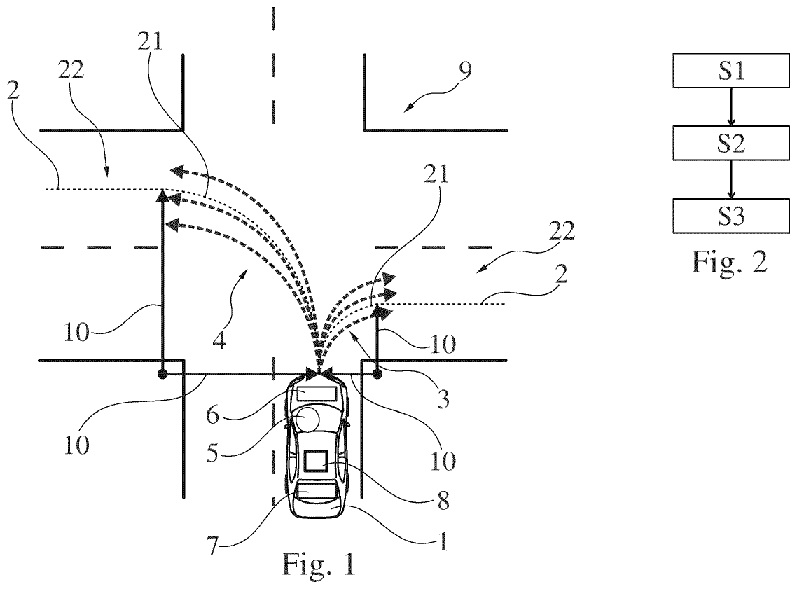

The motor vehicle 1, which is shown merely schematically in FIG. 1, has a steering wheel 5, a front axle steering 6, a rear axle steering 7, the aforementioned three parts being parts of a steering, or steering system, of the motor vehicle 1, and a control device 8 that is connected to the front axle steering 6, the rear axle steering 7 and the steering wheel 5. In this case, the steering system, or steering, of the motor vehicle 1 is a so-called steer-by-wire system. Steer-by-wire is understood to mean a system in vehicle engineering in which a steering command is relayed exclusively electrically (but optionally with a mechanical fallback level) from the steering wheel 5 via one or more controllers to a respective electromechanical actuator of the front axle steering 6 and rear axle steering 7, which executes the steering command. Such a system has no mechanical connection between the steering wheel 5 and the steered wheels of the motor vehicle 1.

The motor vehicle 1 shown in FIG. 1 is nearing an intersection 9 at which, under the control of the control device 9, it will turn either right or left. To control the turning process, the control device carries out the (control) method described in detail below, also with reference to FIG. 2.

In a first step S1 of the method, the control device 8 determines, or identifies, a target trajectory 21 for cornering, which in this case is a turning maneuver of the motor vehicle 1. The control device 8 determines the target trajectory 21 in this case on the basis of a present position of the motor vehicle 1 and map data that store a lane centerline 2 of a turning lane 22. It should be noted that, additionally or alternatively, a trajectory stored in the map data, which, based on recorded trajectories, come from multiple motor vehicles of a motor vehicle fleet that have already performed the turning maneuver, can be used for determining the target trajectory 21. It is also conceivable, additionally or alternatively, that is to say optionally even without the map data, for the control device 8 to determine the target trajectory 21 on the basis of a lane guidance that has been determined on the basis of sensor data from an environment sensor system (not shown) of the motor vehicle 1.

In a second step S2 of the method, the control device 8 determines, or identifies, a profile of a curve radius 10 of the target trajectory 21 on the basis of the target trajectory 21. Depending on which target trajectory 21 has been identified in the first step S1, different trajectories being possible here, as indicated by further possible target trajectories 3 or 4 in FIG. 1, the curve radius 10 can vary along the turning maneuver. This is the case in the example shown in FIG. 1, for example, when the motor vehicle 1 is turning left. During the left turn, the curve radius 10 increases over the course of the turning maneuver, i.e. the curvature of the target trajectory 21 decreases.

In a third step S3 of the method, the controller 8 controls the front and rear axle steerings 6, 7, to be more precise the actuator system provided for each of them, and thus at least the lateral guidance of the motor vehicle 1 on the basis of the identified profile of the curve radius 10 such that the motor vehicle 1 follows the target trajectory 21 as exactly as possible during the turning maneuver. It is also conceivable for the controller to perform the turning maneuver in a fully automated manner, i.e. to also control the longitudinal guidance of the motor vehicle 1 during the turning maneuver in addition to the lateral guidance. In so doing, the controller 8 takes into consideration a yaw rate, a longitudinal acceleration and/or a lateral acceleration of the motor vehicle 1, which have been determined on the basis of sensor data from at least one driving dynamics sensor (not shown) of the motor vehicle 1. The steering can also be controlled in various combinable ways. By way of example, continuous control of a steering ratio of the steering, and/or setting of a fixed value for the steering ratio, optionally according to a mean value of the curve radius 10, can be performed by the control device 8. However, the steering can also be controlled, additionally or alternatively, such that a steering wheel angle of the steering wheel 5 of the steering of the motor vehicle 1 does not exceed a predetermined maximum steering wheel angle, i.e. so that a driver does not have to cross hands during the turning maneuver.

### LIST OF REFERENCE SIGNS

1 motor vehicle
2 lane center
21 target trajectory
22 turning lane
3 variance of target trajectory for right turning maneuver
4 variance of target trajectory for left turning maneuver
5 steering wheel
6 front axle steering
7 rear axle steering
8 controller
9 intersection
10 curve radius
S1-S3 method steps

1-10. (canceled)

11. A control device for controlling the operation of a motor vehicle, the control device comprising:
an electronic control unit of a driving assistance system, the electronic control unit configured to:
identify a profile of a curve radius and/or curve curvature, and
control a steering of the motor vehicle based on the identified profile, wherein controlling the steering comprises continuously controlling a steering ratio of the steering and/or setting a fixed value for the steering ratio based on the curve radius and/or curve curvature.

12. The control device of claim 11, wherein the electronic control unit is further configured to:
identify a target trajectory of the motor vehicle for a cornering, and
identify the profile of the curve radius and/or curve curvature based on the target trajectory.

13. The control device of claim 12, wherein the electronic control unit is further configured to determine the target trajectory based on a present position of the motor vehicle and map data.

14. The control device of claim 13,
wherein the map data comprise a lane centerline of a turning lane and/or a trajectory of at least one motor vehicle that has already performed the cornering, and
wherein the electronic control unit is further configured to identify the target trajectory based on the lane centerline and/or the trajectory.

15. The control device of claim 11, wherein the electronic control unit is further configured to determine the target trajectory based on a lane guidance that has been determined form sensor data of an environment sensor system of the motor vehicle.

16. The control device of claim 11, wherein the electronic control unit is further configured consider: a yaw rate, a longitudinal acceleration, and/or a lateral acceleration of the motor vehicle, determined based on sensor data from at least one driving dynamics sensor of the motor vehicle, when generating the control signal.

17. The control device of claim 11, wherein the steering is controlled such that a steering wheel angle of a steering wheel of the steering of the motor vehicle does not exceed a predetermined maximum steering wheel angle.

18. A motor vehicle comprising the control device of claim 11.

19. A method for controlling the operation of a motor vehicle, the method comprising:
identifying a profile of a curve radius and/or curve curvature; and
controlling a steering of the motor vehicle based on the identified profile of the curve radius and/or curve curvature,
wherein the control of the steering comprises continuous control of a steering ratio of the steering and/or setting of a fixed value for the steering ratio, based on the curve radius and/or curve curvature.

20. A non-transitory computer readable medium storing instructions executable by a computing device to carry out the method of claim 19.
